(19) United States
(12) Patent Application Publication
(10) Pub. No.: US 2008/0298051 A1
(43) Pub. Date: Dec. 4, 2008

(54) Flat-plate lighting device

(76) Inventor: Ko-Chien Chu, Taoyuan city (TW)

Correspondence Address: PRO-TECHTOR INTERNATIONAL, 20775 Norada Court, Saratoga, CA, 95070-3018, US

(21) Appl. No.: 11/807,852

(22) Filed: May 29, 2007

(51) Int. Cl. F21L 4/08

(52) U.S. Cl. 362/183

(57) ABSTRACT

A flat-plate lighting device comprising a lamp body and a lamp post; the lamp body related to a flat-plate frame having on its top disposed with a sheet matrix-like arrangement of a solar moudle, and on its inner-bottom connected to a light emitting area and a accommodation area with the lighting emitting area comprised of one or a plurality of lighting unit of LED and the accommodation area being related to a thicker box; the box contains a solar cell and a circuit board, the circuit board converts the sunlight energy from the solar moudle into electric energy and stored in the solar cell; the power is supplied to the lighting unit once a electro-optical sensor detects insufficient ambient luminance; and a power monitor circuit is added to the circuit board.

### BACKGROUND OF THE INVENTION

(a) Field of the Invention

The present invention is related to a lighting device, and more particularly, which use solar powered be a flat-plate type frame and let LED lighting unit combination mounted to a lamp post lantern in building or street-light or garden-light.

(b) Description of the Prior Art

Electric appliances and computer have become a must today thanks to rapid development of modern technology. Lighting during night hours not only serves for illumination use but also decoration and landscaping purposes. However, the energy resource is very limited. Petrol oil as the most important energy source is about to be consumed up if not wasted. Solar energy is an inexhaustible energy source, and the cheapest one. Many people with visions have been aggressively promoting the application to this regard. Whereas the solar energy is essentially applied on a wafer type collector, many lighting devices operating on solar energy generally available in the market manage to achieve 12˜17% of transfer rate to convert to convert photo energy into electric energy. Based on the transfer rate, street-light or garden-light post lantern for consuming less power and being lighted only during night hours to allow sufficient time during day hours to collect solar energy and reserved for use at night has become a focus of development in recent years. Though many lighting devices operating on solar energy have been introduced, some of them remain relying upon the existing lighting device. As a result, brighter luminance is realized but the durability is compromised. Other installations having the solar energy moudle and the lighting device separately provided however complicate in assembly work while failing to fit in the view of the landscape; furthermore, each type of those installations is specially designed to prevent it from coping assembly requirements or creating significant changes. The prior art has affected both applicability and adaptability of the lighting device in generally.

### SUMMARY OF THE INVENTION

The primary purpose of the present invention is to provide a flat-plate lighting device designed as an integral part using the concept of module and conception of being compact and collective to come up with a structure of ultra thin, LED lighting device that permits extension of the number of lamp body to correct problems found with the prior art.

Another purpose of the present invention is to provide a flat-plate lighting device adapted with a power monitor circuit to the circuit board for monitoring the power supply status of each lighting device; once any abnormality on the circuit may be immediate serviced by the regulating entity executing the remote control without relying upon a service call from the user. Permitting the remote monitor is a feature significantly distinguished the present invention from those lighting devices of the prior art.

To achieve those purposes described above, the present invention is connected with a lamp body and a lamp post; the lamp body relates to a flat-plate frame having on its top disposed with a sheet matrix-like arrangement of a solar moudle, and on its inner-bottom connected to a light emitting area and a accommodation area with the lighting emitting area comprised of one or a plurality of lighting unit of LED and the accommodation area related to a thicker box; the box contains a solar cell and a circuit board, the circuit board converts the sunlight energy from the solar moudle into electric energy and stored in the solar cell; the power is supplied to the lighting unit once a electro-optical sensor detects insufficient ambient luminance; and a power monitor circuit is added to the circuit board.

### BRIEF DESCRIPTION OF THE DRAWINGS

FIG. 1 is a side view of the present invention (with frame opened up).

FIG. 2 is a perspective view from the top of the present invention.

FIG. 3 is a perspective view of the present invention from bottom.

FIG. 4 is a bottom view of the present invention including one lighting unit.

FIG. 5 is a bottom view of the present invention including two lighting units.

FIG. 6 is a bottom view of the present invention including three lighting units.

FIG. 7 is a bottom view of the present invention including four lighting units.

FIG. 8 is a bottom view of the present invention including six lighting units.

FIG. 9 is a block view of a circuit of the present invention.

FIG. 10 is a block view of a partial circuit diagram of the present invention including two lighting units.

FIG. 11 is a circuit block chart of an additional power monitor circuit to the present invention.

FIG. 12 is a block chart showing a remote power monitor circuit installation of the present invention.

### DETAILED DESCRIPTION OF THE PREFERRED EMBODIMENTS

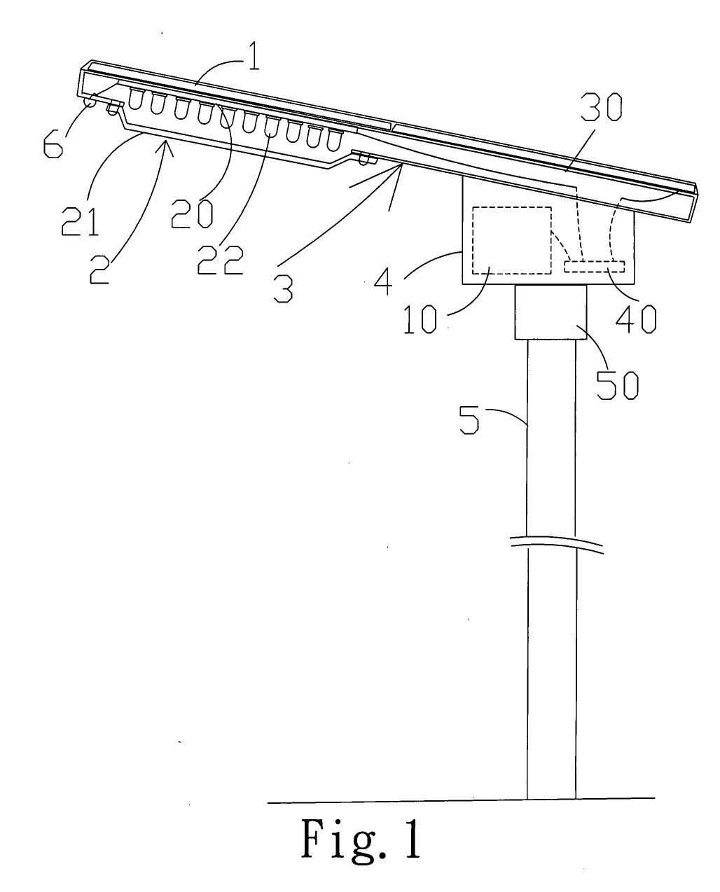

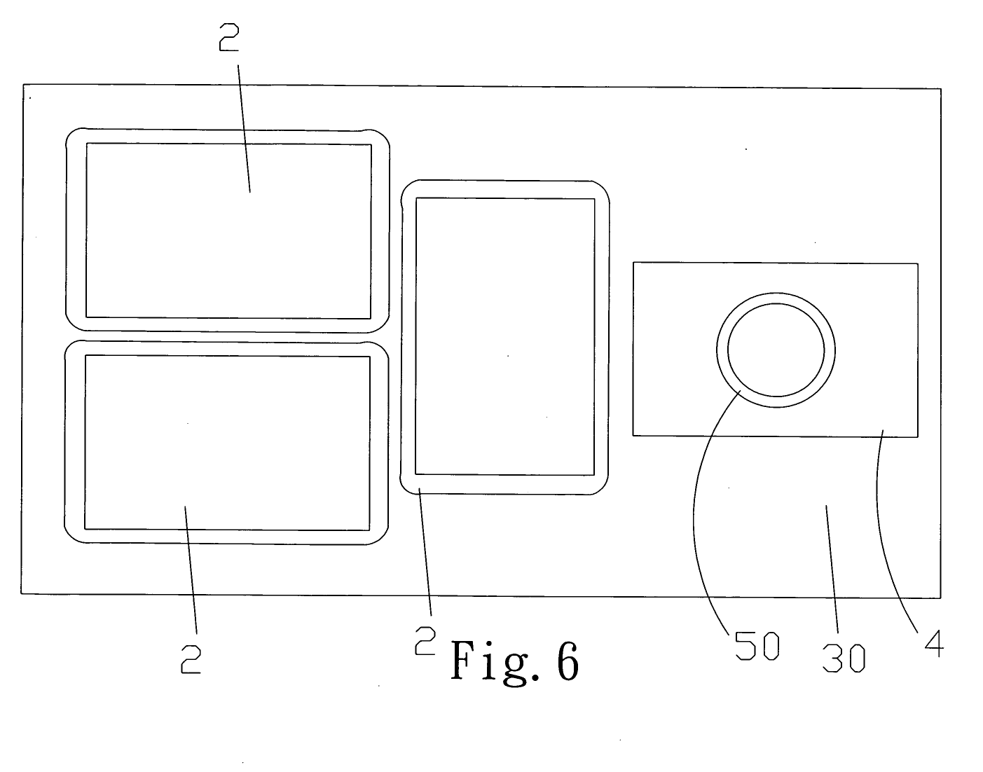

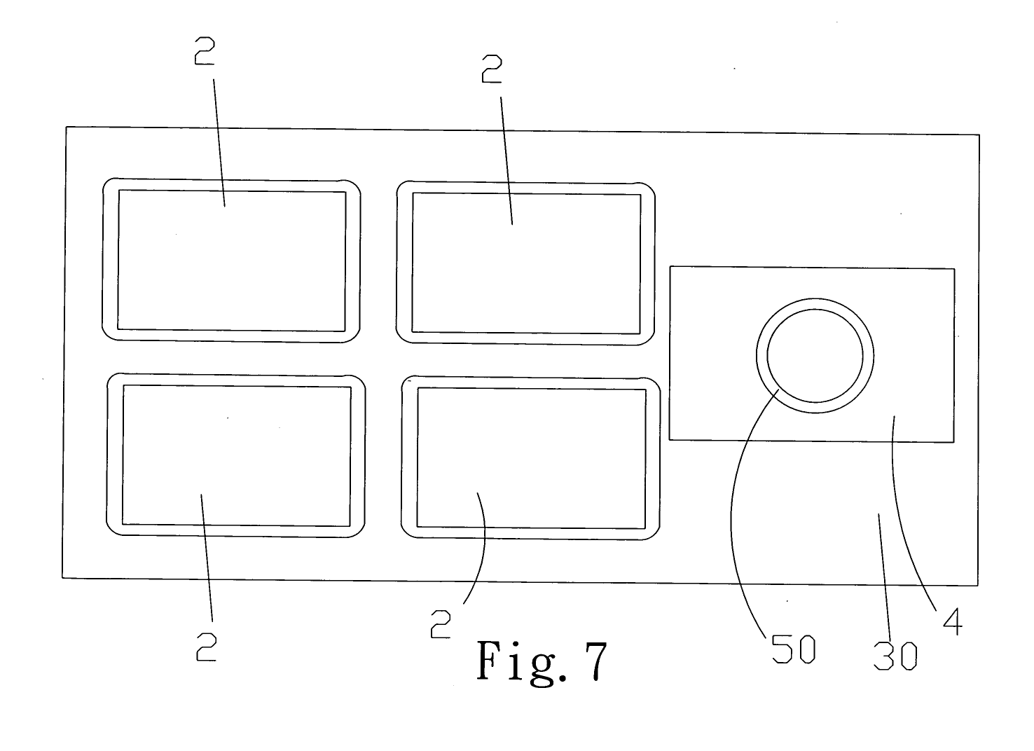

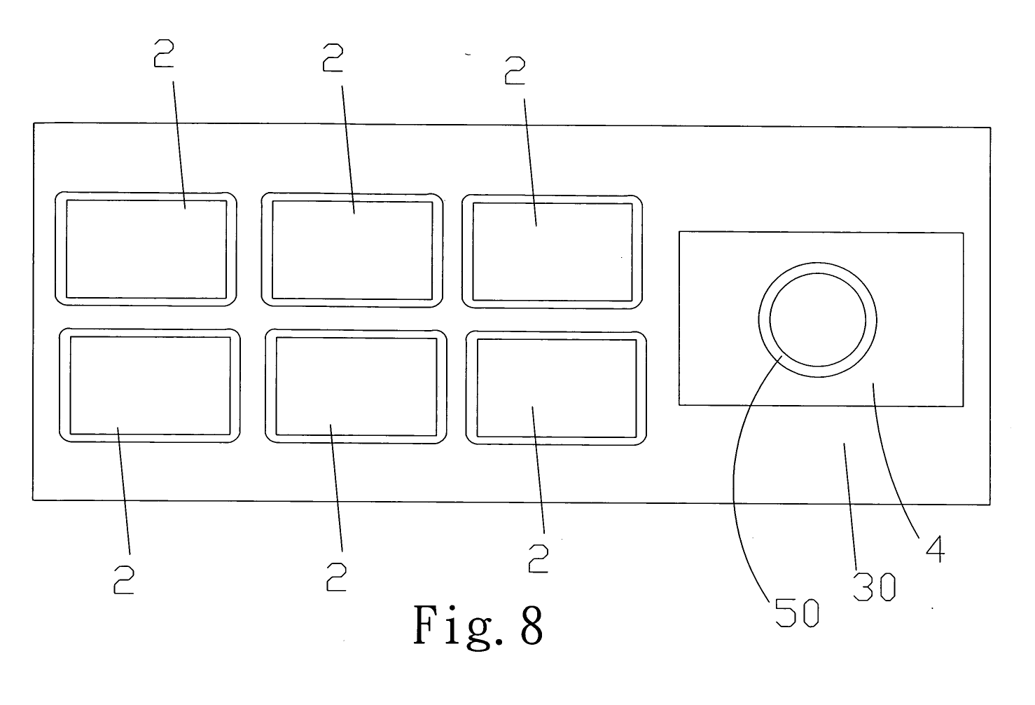

A flat-plate lighting device of the present invention as illustrated in FIGS. 1 through 12. The present invention includes a lamp body 3 and a lamp post 5 connected to each other; the lamp body 3 relates to a flat-plate frame 30 having on its top disposed with a sheet solar moudle 1 arranged in a pattern of matrix; a light-emitting area and an accommodation area are disposed inner-bottom of the frame 30, the light-emitting area contains one or a plurality of lighting unit 2 comprised of multiple light emitting diodes (LEDs); the accommodation area relates to a thicker box 4 containing a solar cell 10 and a circuit board 40, the circuit board 40 receives and converts sunlight energy from the solar moudle 1 into electric energy to be stored in the solar cell 10; the solar cell 10 is activated to supply power to the lighting unit 2 when a electro-optical sensor 6 detects insufficient ambient luminance; and a sleeve 50 is provided to the bottom of the box for connecting the box 4 to the lamp post 5.

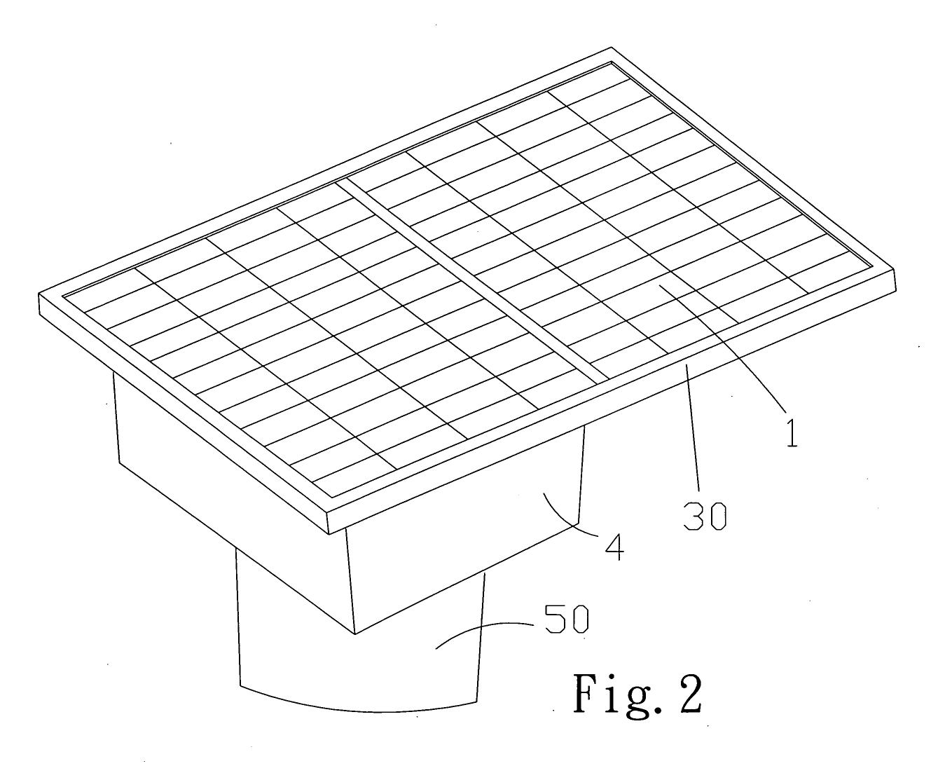

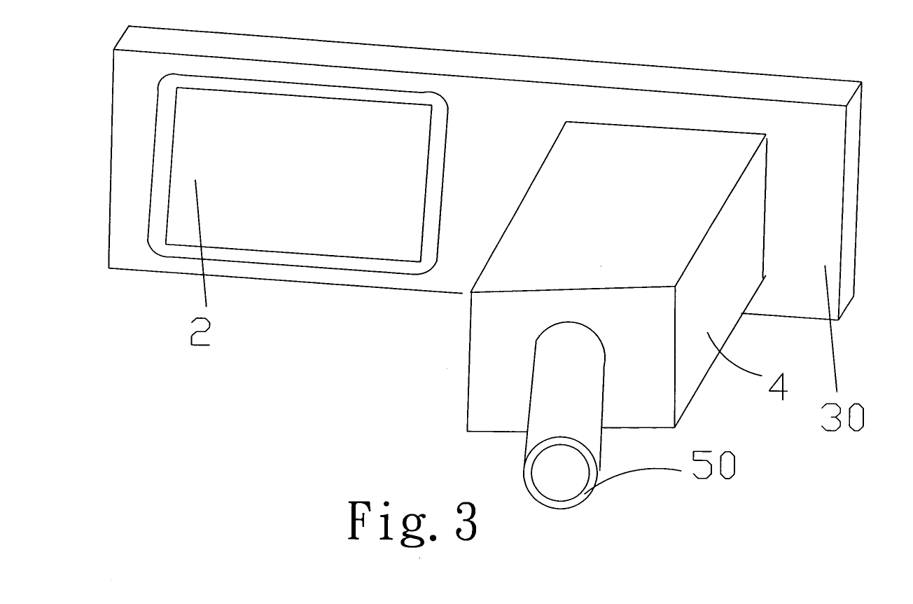

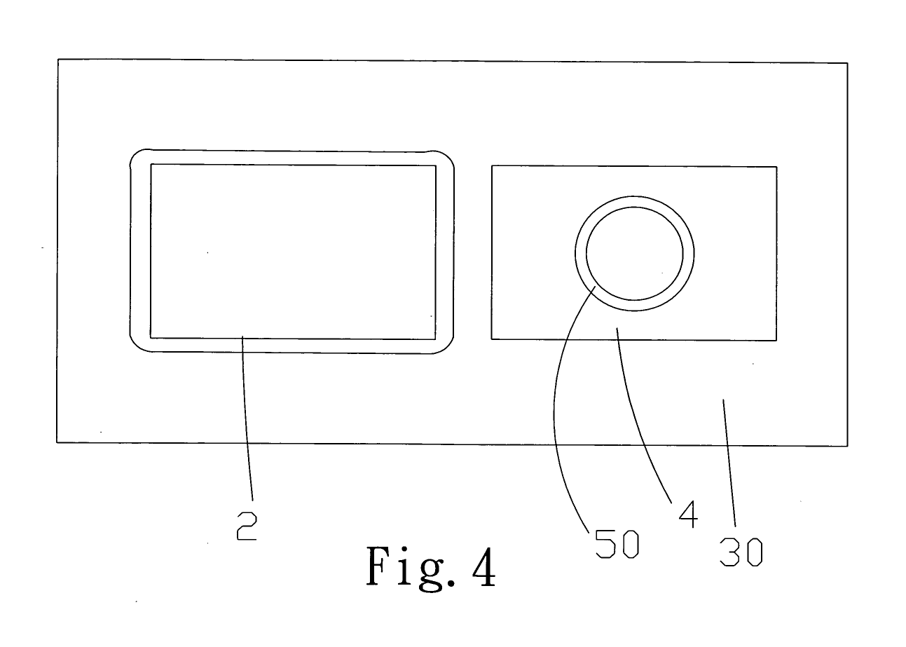

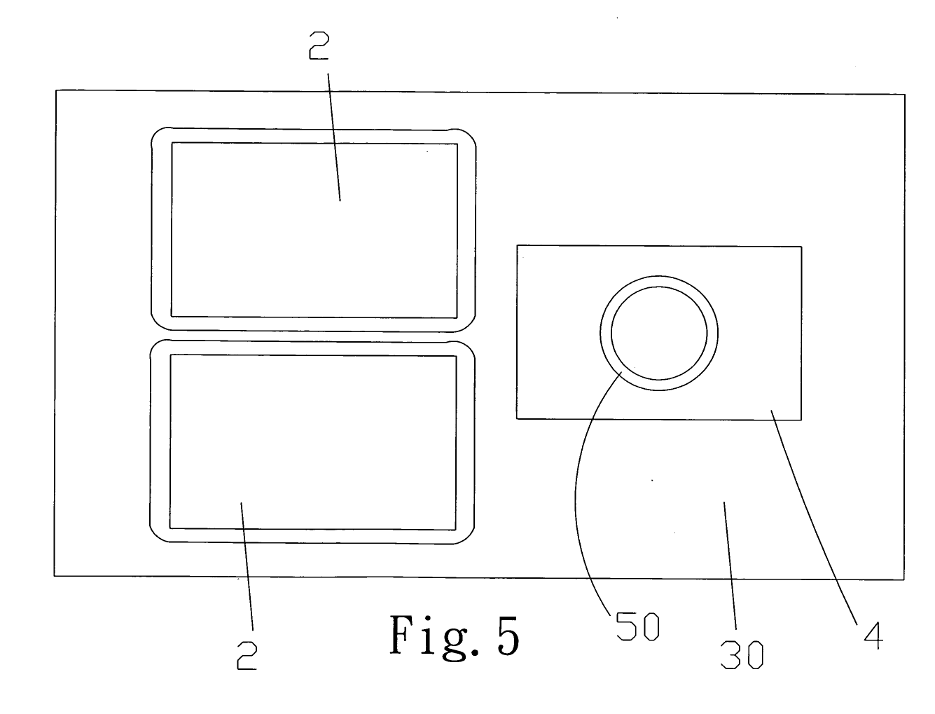

Referring to FIG. 1, the sheet frame 30 upwardly and outwardly indicates an angle of elevation in relation to the box 4 to expand lighting coverage. As illustrated in FIGS. 2 and 3, there is only one lighting unit 2 provided in the light-emitting area of the box as also illustrated in FIG. 4 showing a view of the bottom of the box 4. Multiple lighting units 2 may be provided as applicable. Two lighting units 2, 3, 4, and 6 (in 3×2 matrix) are provided as respectively illustrated in FIGS. 5, 6, 7, and 8.

As illustrated in FIG. 1, the lighting unit 2 includes the circuit board 20 mounted with multiple LEDs 22 contained in a lampshade 21; the lampshade 21 is connected to the frame 30 (on bottom) by means of multiple screws; a electro-optical sensor 6, generally known as a sensitive resistance is provided to detect luminance and is connected to the circuit board 40, and the circuit board 20 of the lighting unit 2 is also connected to the circuit board 40 in the box 4; and both of the solar moudle 1 and the solar cell 10 are also connected to the circuit board 40 in the box 4 for the box 4 to become an accommodation space for integration having one side of the box 4 is located with a lock to facilitate service.

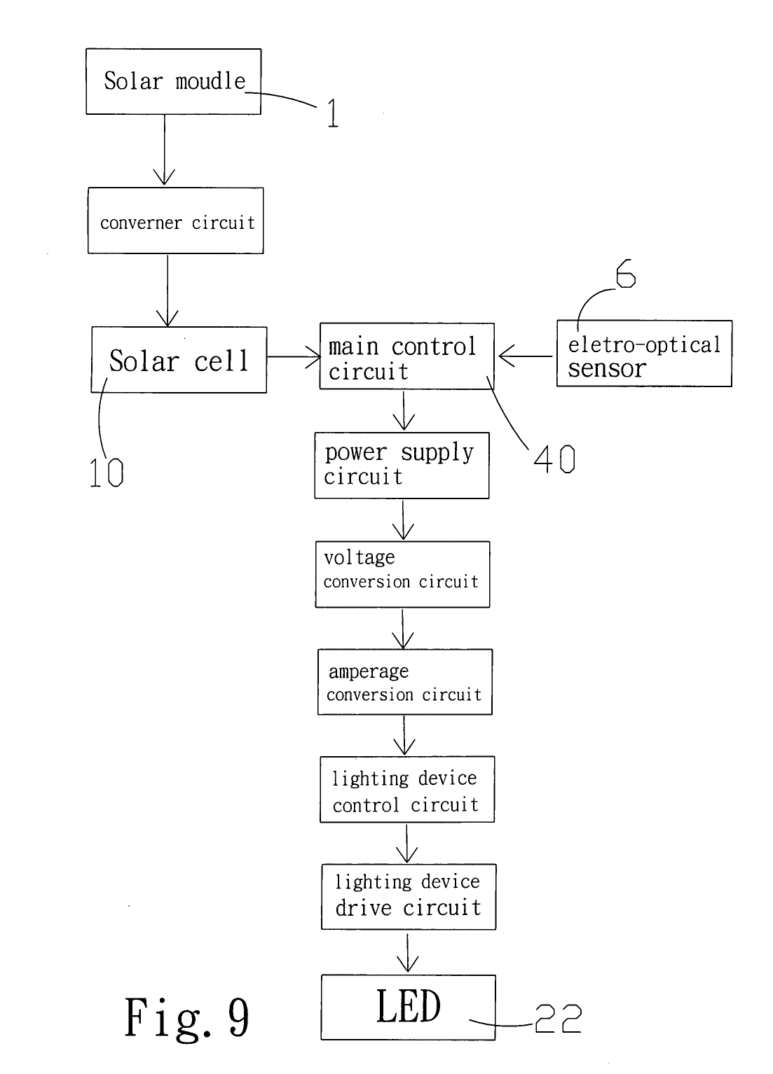

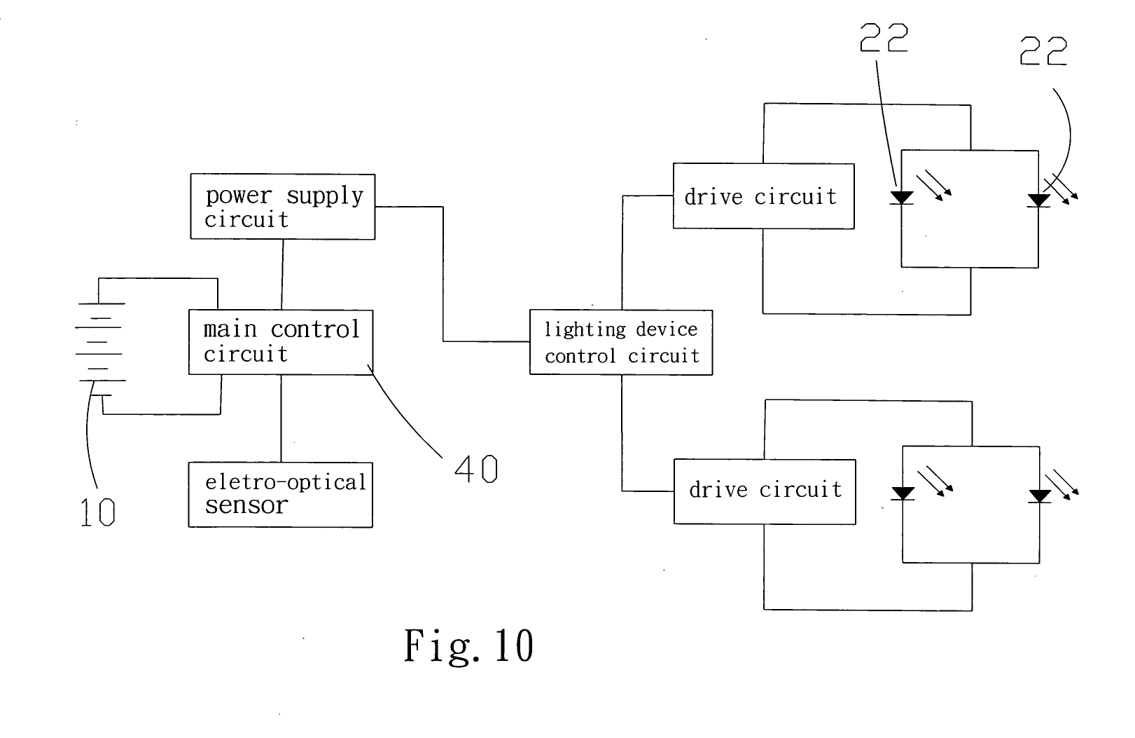

As illustrated in FIG. 9 showing a circuit block chart and FIG. 10 showing a partial circuit diagram for a general operation of the present invention, sunlight energy from sun beams arriving on the solar moudle 1 is converted through a conversion circuit disposed on the circuit board 40 into electric energy to be stored in the solar cell. Once the electro-optical sensor 6 detects insufficient ambient luminance, a signal advising the insufficiency is sent to a main control circuit (also designated with the number of 40) on the circuit board 40 to activate a power supply circuit. Depending on number of the lighting unit 2, DC power is supplied to a lighting device control circuit through a voltage conversion circuit and an amperage conversion circuit; and a lighting device drive circuit in turn drives each LED 22 disposed on the circuit board 20 of the lighting unit 2 to emit light. FIG. 10 shows a working status of multiple LEDs 22 from two lighting units connected in parallel.

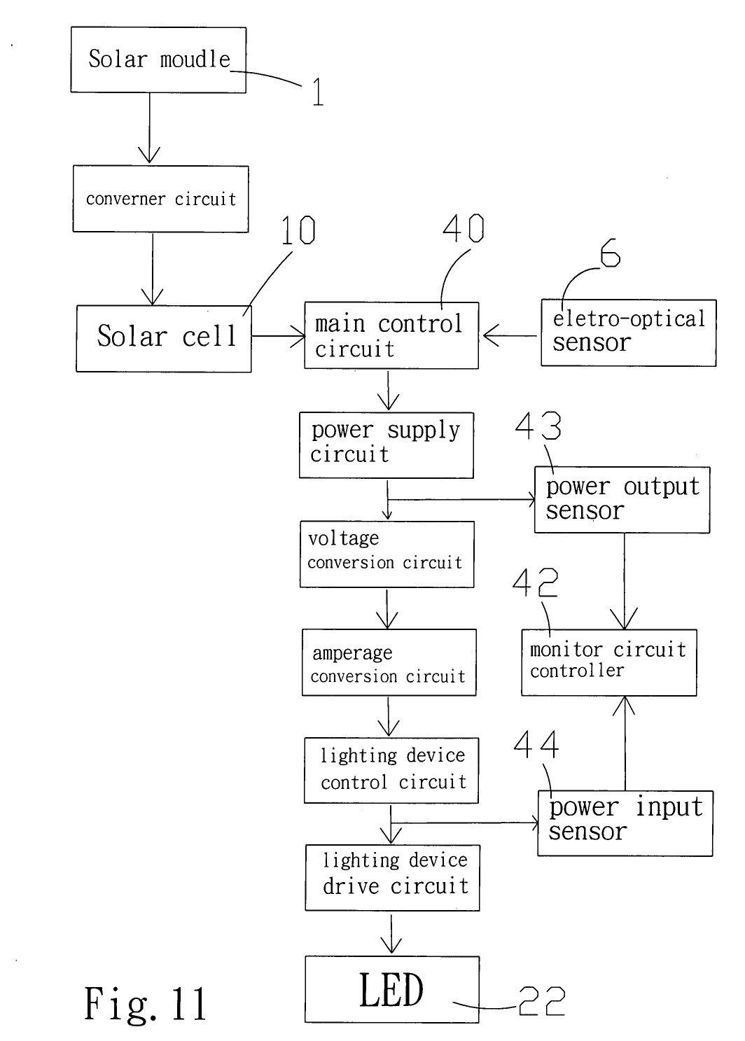

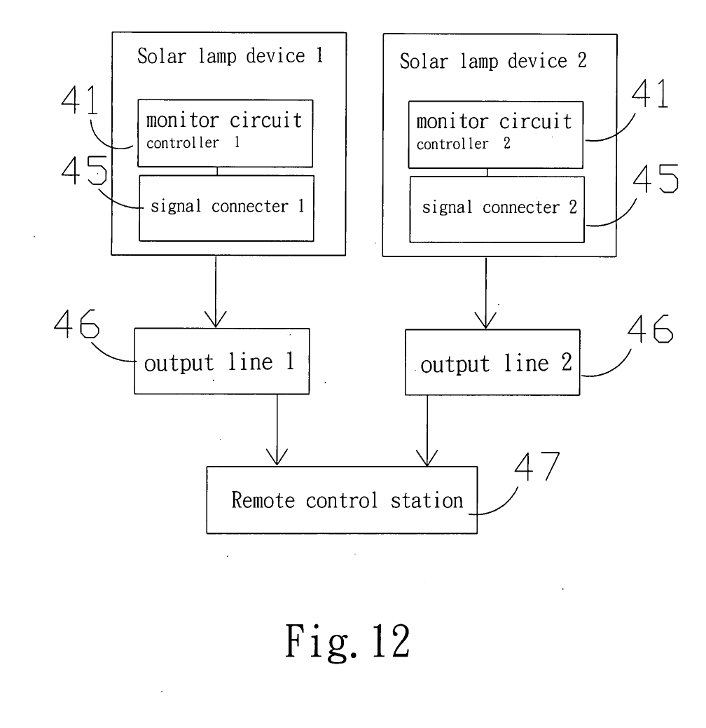

A power monitor circuit 41 is added to the circuit board 40 in the box 4 of the present invention as illustrated in FIG. 11; wherein a central unit of the power monitor circuit 41 relates to a controller 42, the controller 42 executes control in the form of microprocessor software, a programmable controller, a similar design, or even a mini-computer to function as a signal control center for periodically receiving and processing signals from the electro-optical sensor for relay. Whereas the present invention is related to a lighting device, power supply and light emission are only two functions that warrant monitor. Accordingly, an addition of a power output sensor 43 is added to the power supply circuit at the rear end of the main control circuit 40 to detect if normal and sufficient power output presents for judgment of sufficient power output or damaged solar cell 10 by the controller based on a preset data. Furthermore, a power input sensor 44 is connected in parallel with the drive circuit to detect if normal power is supplied to the lighting device and if the circuit is normal. For signal process for a single lighting device, another photosensitive switch is provided to sense the light emitting status of the lighting unit 2. On the part of signal output as illustrated in FIG. 12, the monitor circuit 41 of each lighting device is provided with a signal connecter 45, which is connected to a remote control station 47 via an output line 46. The output line 46 may be related to a subscriber line or an automatic dialing telephone circuit so to constitute a parallel manipulation of network for facilitating real-time control by a remote control entity to pick up messages from each lighting device in case that an immediate service is needed.

Based on the design concept of an integral part, the present invention combines the lighting device and the solar moudle in the frame while having the solar cell separately built in the box to achieve an all-in-one combination. A corresponding relation exists between the number of lighting unit and that of the solar moudle since the latter increases as the former does. That is, if 12V is needed for the operation of the lighting unit comprised of 60 LEDs, it requires a power specification of 12 A and 14 W; and 40 A and 40 W, in case of three lighting unit. Accordingly, modularization is realized for the lamp body of the present invention. The upright and foursquare construction of the present invention features thin and light upper portion and thick and heavy lower portion to deliver attractive appearance and sufficient luminance while allowing easy service and replacement. The present invention provides excellent utility and is related to a mechanism that is totally different from that of the prior art.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A flat-plate lighting device including a lamp body and a lamp post connected to each other; the lamp body being related to a flat-plate frame, a sheet solar moudle arranged in a pattern of matrix being disposed on a top of the frame; a lighting emitting area and an accommodation are being disposed to inner-bottom of the frame; the light-emitting area including one or a plurality of lighting unit containing multiple light emitting diodes; the accommodation area related to a thicker box containing a solar cell and a circuit board; said the box connected to the lamp post; the circuit board converting sunlight energy delivered from the solar moudle into electric energy to be stored in the solar cell; and the circuit board being activated to supply power to the lighting unit in case of insufficient ambient luminance.

2. The flat-plate lighting device as claimed in claim 1, wherein a electro-optical sensor is connected to the circuit board.

3. The flat-plate lighting device as claimed in claim 1, wherein a power monitor circuit is added to the circuit board; the power monitor circuit being provided with a controller; the controller being disposed with a circuit output sensor connected in parallel with a power supply circuit disposed to the rear of the main control circuit on the circuit board; a signal connecter being disposed to the power monitor circuit and connected via an output line to a remote control station.

4. The flat-plate lighting device as claimed in claim 1, wherein a power input sensor is provided to the power monitor circuit added to the circuit board; and the power input sensor is connected in parallel to a drive circuit associate with the lighting unit provided on a main control circuit of the circuit board.
